(19) United States
(12) Patent Application Publication
(10) Pub. No.: US 2012/0165959 A1
(43) Pub. Date: Jun. 28, 2012

(54) INTECONNECTING GRIDS OF DEVICES OF NETWORKED CONTROL SYSTEMS

(75) Inventors: Petrus D. V. Van Der Stok, Helmond (NL); Willem F. Pasveer, Dordrecht (NL)

(73) Assignee: KONINKLIJKE PHILIPS ELECTRONICS N.V., EINDHOVEN (NL)

(21) Appl. No.: 13/386,509

(22) PCT Filed: Jul. 19, 2010
(86) PCT No.: PCT/IB2010/053270

§ 371 Date: Mar. 19, 2012

(30) Foreign Application Priority Data
Jul. 24, 2009 (EP) 09166337.7

(51) Int. Cl. G05B 11/01

(52) U.S. Cl. 700/11

(57) ABSTRACT

The invention relates to interconnecting grids of devices of networked control systems, particularly to interconnecting lighting systems having grids of interconnected luminairies. A basic idea of the invention is to interconnect grids of devices of networked control systems such as luminairies of lighting systems installed in different units of a building and to provide an address assigning scheme for devices of the interconnected grid so that all devices of the interconnected grids may be unambiguously addressed.

### FIELD OF THE INVENTION

The invention relates to interconnecting grids of devices of networked control systems, particularly to interconnecting lighting systems having grids of interconnected luminairies.

### BACKGROUND OF THE INVENTION

Networked control systems are a ubiquitous trend in commercial, industrial and institutional business markets and also in consumer markets. An example of a networked control system is a complex lighting system with dozens of light sources. Examples of professional environments are lighting systems applied in green houses, factory buildings, sport halls, office buildings and outdoor (matrix) light displays. Particularly, in professional environments it becomes more and more interesting to control devices of a networked control system on an individual and local basis, for example in order to save energy in large lighting systems or for light scene settings. Controlling of devices may be based on sensor and human input.

Individual control of devices of a networked control system may be implemented by attaching a node comprising a CPU and a network connection to one or more devices that needs control. The nodes are inter-connected by a wired or wireless network. Each node has a network address to which a message for the given node can be sent. Messages can be sent to nodes of one grid, but usually not to nodes of other grids.

WO2007/102114A1 relates to grouping of wireless communication nodes in a wireless communication network, which are configured to control the operation of luminaries in a lighting array. A computer algorithm for grouping a derived spatial arrangement of wireless communication nodes is provided. The position of each node in the communication network corresponds to the position of a particular luminaire in the lighting array. The algorithm divides the arrangement of nodes into a plurality of spatial groups, each of which is defined by a line which joins the group's member nodes together. The groups are ranked according to their statistical attributes and a number of groups are selected as control groups, such that the member nodes, and hence luminaries, of each control group may be controlled by a single switch or sensor.

### SUMMARY OF THE INVENTION

It is an object of the invention to provide a system, method, and device(s), which allow an interwork between grids of devices of networked control systems.

The object is solved by the subject matter of the independent claims. Further embodiments are shown by the dependent claims.

A basic idea of the invention is to interconnect grids of devices of networked control systems such as luminairies of lighting systems installed in different units of a building and to provide an address assigning scheme for devices of the interconnected grid so that all devices of the interconnected grids may be unambiguously addressed. Thus, different grids of devices may be combined to an overall networked control system, which may be for example controlled by related controlling devices in the same grid as the controlled devices or by one or more centrally located devices outside the grids.

An embodiment of the invention provides a method for interconnecting grids of devices of networked control systems comprising
providing interconnections between the grids and
providing an address assigning scheme for the devices of the interconnected grids.

By providing an address assigning scheme for the interconnected grid, it is possible to address each device of the interconnected grids in an uniform manner. Also, it is possible to locate each device in for example a building containing several interconnected grids without ambiguity with reduced human intervention.

The providing of interconnections between the grids may comprise providing point-to-point links between devices of different grids. Point-to-point links may be provided for example at opposite edges of grids, for example between two grids, which are located in neighbored rooms in a building.

The providing of an addressing scheme for the devices of the interconnected grids may comprise assigning unique addresses to the devices of the interconnected grids. For example, the addressing scheme of one grid may be applied to the interconnected grids in such a way that the address space of the one grid is extended to the interconnected grids. The numbering of devices according to the provided addressing scheme may be continuous or discontinuous if for example the density of devices in interconnected grids differ. Thus, a single grid may be created from the interconnected grids.

The assigning of unique addresses to the devices of the interconnected grids may comprise exchanging configuration messages over the point-to-point links between the grids, wherein the configurations messages initiate a change of the addresses of the devices of the interconnected grids. The exchanged configuration messages may for example be sent from one grid to the interconnected grids over the point-to-point links and transport the addressing of the one grid to the interconnected grids so that the later grids can continue the addressing of the one grid. The configuration messages may be for example contain an address counter, which may be used by a receiving device to update its address and to increment the address counter before forwarding the configuration message to the next device for an address update. In such a way, an automatic update of the addresses of interconnected grids may be accomplished by exchanging configuration messages.

A change of the addresses of grid may depend on one or more point-to-point links of the grid with another grid. The address of a device of one grid connected to the device of another grid via a point-to-point link may be for example determine the change of the address of the other device.

The providing of interconnections between the grids may also comprise providing grid gateway nodes connecting the grids. Instead of creating a single grid, a grid of grids is created with the grid gateway nodes. A grid gateway node may route messages between the grids being connected by the grid gateway node. Thus, a grid gateway node may control the “traffic” between grids.

The method may further comprise the interconnecting of a grid of sensors with the interconnected grids of devices of networked control systems. Thus, also sensor grids may be integrated in the interconnected grids and the address space so that a sensor may be treated as a device and addressed in the same way as devices in the networked control system. Control programs do not see any addressing difference but can be adapted to distinguish between the functions of the devices given their type and location.

The providing of an addressing scheme for the devices of the interconnected grids may comprise assigning grid addresses to each grid for addressing grids, wherein a grid address is used for routing messages through the interconnected grids. A message may for example contain a grid address and the address of the destination device in the addressed grid. With these addresses, the message may be routed through the entire grid to the destination device.

An embodiment of the invention provides a computer program enabling a processor to carry out the method according to the invention and as described above.

According to a further embodiment of the invention, a record carrier storing a computer program according to the invention may be provided, for example a CD-ROM, a DVD, a memory card, a diskette, internet memory device or a similar data carrier suitable to store the computer program for optical or electronic access.

A further embodiment of the invention provides a computer programmed to perform a method according to the invention such as a PC (Personal Computer).

A further embodiment of the invention provides a system for interconnecting grids of devices of networked control systems, wherein the system is adapted for performing the acts of
providing interconnections between the grids and
providing an address assigning scheme for the devices of the interconnected grids.

The system may be further adapted to perform a method of the invention and as described above.

Furthermore, an embodiment of the invention relates to a grid gateway node being adapted for application in a system of the invention and as described before, wherein the node comprises
routing means for routing messages between different grids being connected by the grid connection node.

The routing means may be adapted to route messages by extracting a grid address from a received message and to route the message to the destination device of the grid specified by the grid address.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

FIG. 1 shows an example of grids of several networked lighting systems on a floor of a building;

FIG. 2 shows the grids of FIG. 1 interconnected with point-to-point links according to the invention;

FIG. 3 shows the grids of FIG. 1 interconnected with grid gateway nodes according to the invention;

FIG. 4 shows an embodiment of a grid gateway node connecting two grids according to the invention;

FIG. 5 shows a flowchart of an embodiment of a method for interconnecting grids of devices of networked control systems according to the invention;

FIG. 6 shows an embodiment of an integration of sensor and luminaire grids according to the invention; and

FIG. 7 shows a further embodiment of an integration of sensor and luminaire grids according to the invention.

### DETAILED DESCRIPTION OF EMBODIMENTS

In the following, functionally similar or identical elements may have the same reference numerals. Even if embodiments of the invention, which are described in the following, relate to lighting systems, the invention is generally applicable to networked control systems, which comprise several devices arranged in a grid. The terms “light” and “luminaire” describe the same.

In professional environments it becomes more and more interesting to control lights on an individual and local basis. Examples of such environments are green houses, factory buildings, sport halls, office buildings and outdoor (matrix) light displays. Instead of switching on or off all luminaries, it is preferred to control single luminaries or groups of luminaries in order to locally create light effects in certain areas, for example in order to illuminate certain areas in an office building or to create light for only some plants in a certain place in a green house. Also, often it is required to individually control luminaries of a lighting system with for example a central controller of the lighting system, which is only possible if all luminaries of the lighting system are commissioned, i.e. are recorded in a database of the computer with their at least relative location in the lighting installation so that an operator can decide which luminaire to activate. Complex lighting systems are usually organized as networked control systems, which means that the devices of the system such as luminaries or groups of luminaries are part of a network and may be individually addressed and controlled for example by control messages. The control messages can be centrally generated, e.g. by a central controller such as computer provided for controlling luminaries of for example an outdoor (matrix) light display, but might also be based on local sensor findings, e.g. in a lighting system for greenhouses or offices.

Individual control of luminaries in such networked lighting systems may be done by attaching a communication node to each luminaire that needs to be controlled, e.g. ballast. The node may be integrated in the luminaire or attached as separate device. A node may comprise a microcontroller being programmed to receive and execute control commands addressed to the respective node. The addressable node forms a device of a networked control system. A node may control a single luminaire or several luminaries. In a networked lighting system, each of the nodes has a unique network address, so that messages from a given controller can be directly addressed and routed to it. A message means any control command for controlling devices attached to an addressed node, for example “dimming of all luminaries connected to node with address xyz” or “activating the luminaire at node with address xyz”. The messages or control commands are sent to a node or a group of nodes at a given location within a building or an environment, to regulate the lighting at the given location. Lights of a lighting system can be also controlled on the basis of sensor values or humans pushing actuators, for example light switches. The lights may be connected with individual wires to a switching point, or connected with a wired bus system to a control point connected with wireless communication technology.

The lights of lighting system installations in building units such as in an office are often organized in rectangular grids. Particularly, four types of units can be discerned, although other unit types can be envisaged:
1. Small office space (1-4 occupants)
2. Large office space (open office space with many desks)
3. Corridors (connecting the office spaces)
4. Reception areas

Within the first two unit types the lights are usually arranged in rectangular patterns. Sensors can be arranged in another rectangular pattern within the same space. Within unit type 3 (corridor) lights are usually arranged in one or more lines. While in unit 4 light grids of different types of luminaires may co-exist. Sometimes a more complex circle segment pattern is used. Within each building unit the lights can automatically find their grid locations by using an auto-commissioning method. With the invention and as described in the following, the grids can be interconnected to automatically locate each node in the building without ambiguity, while maintaining an automatic allocation of addresses directly related to the position of the nodes and the luminaires connected to it within the building.

Within one unit, a microcontroller (node) may be associated with one or more light points placed in a rectangle. A light point may comprise one or more luminaries. The nodes may be placed in a grid. The position of the nodes in the grid, expressed as a [column, row] pair, represents the location of the nodes. The nodes may be interconnected by point to point communication channels. For some applications it is not always needed to provide all point to point connections between neighbored nodes in the grid. Restricting the connections along only rows, or only columns, may be for some applications sufficient. However when a node fails, all the nodes coming after this node in the communication chain will not receive any commands until the node is repaired. Providing cross links to connect the rows or columns enhances the fault tolerance, such that the failure of one node does not affect any other nodes.

Networks are organized in a mesh network, or star network interconnected with wired or wireless point to point connections, or as a multi-drop wired network, or as a wireless network. According to most standards, the manufacturer allocates a hardware address to the network interface, which is the address of the device used to communicate with his directly connected neighbor. An example of a hardware address is the MAC (Medium Access Control) address according to the Ethernet standard. Usually a network wide address (e.g. Internet address) is given to each node and a mapping between hardware address and network address is established. Network addresses have no relation to the location or function of the device. In this embodiment of the invention, the location of each node is stored in the node. This location is used to address the node directly. Consequently each node may be addressed by its location and no longer by its hardware address or network-wide address.

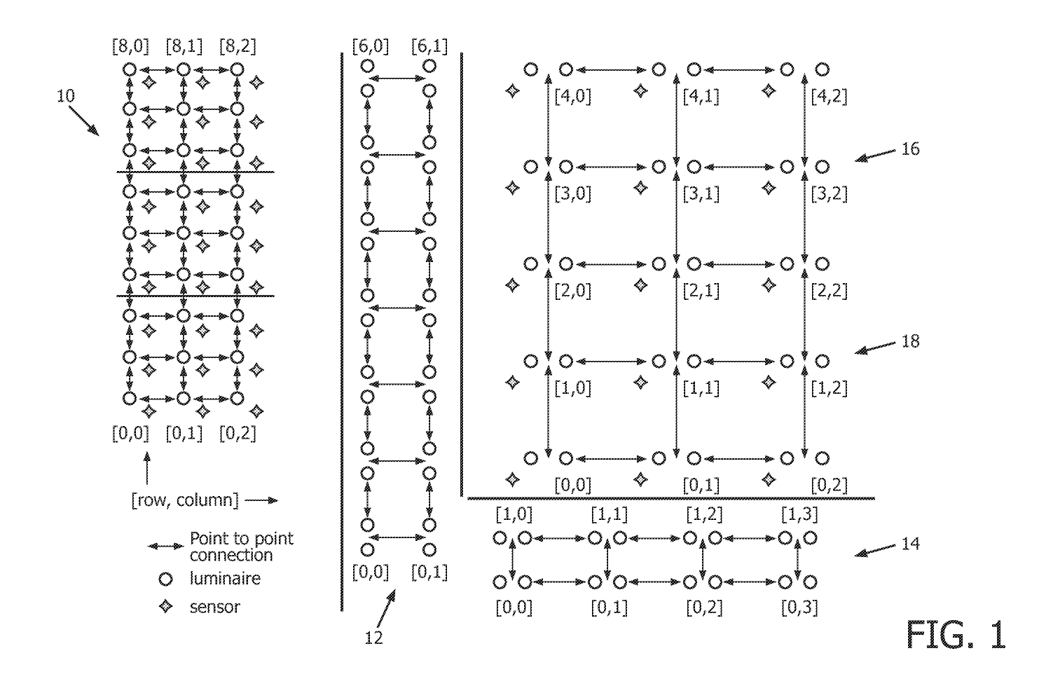

FIG. 1 presents an example office floor. Luminaires are represented with circles and sensors with stars. (Grid) nodes can control one or two luminairies. Reference numeral 18 designates a node. Some of the nodes are designated by their coordinates. On the left hand side of the office floor shown in FIG. 1, a grid 10 of one luminaire per node stretches over 3 offices. On the right hand side a large office or lab space contains one grid 16 of two luminaires per node. In the corridor two grids 12 and 14 of two luminaires per node are present. Thus, the floor comprises four different grids 10, 12, 14, and 16, each having its own addressing scheme. Within each grid communication is possible. Consequently, the values of presence detectors and light sensors can be sent over the grid network to regulate the intensity of the lamps, but cannot be sent between grids. This embodiment of the invention addresses the inter-grid communication

Because the walls can be reconfigured between the three offices, the separation in three networks is not physically imposed for grid 10. In FIG. 1, this results in one grid 10 for the three offices on the left. Dependent on the chosen office spaces, a logical separation between offices is needed. For the three offices on the left hand side connections between sensor and luminaires have to be established on a digital drawing by the architect and are consequently communicated to the building climate programs controlling the lamps.

Communication within a given building unit is not enough. The next step is to interconnect the grids 10, 12, 14 and 16 between them such that floor-wide communication can be done. This may be necessary when a control program for the networked control system runs on a central building-wide computer. In the future, a central controller running the control program for one building unit can be envisaged with the current grid proposal.

Two embodiments for interconnecting the functional grids according to the invention are described and explained in the following:
1. Creating one single grid per floor
2. Creating interconnected grids

Once the lighting grids are interconnected, the lighting network can be connected to the sensor network, as will be described later.

In the first embodiment, one single grid is created per floor:

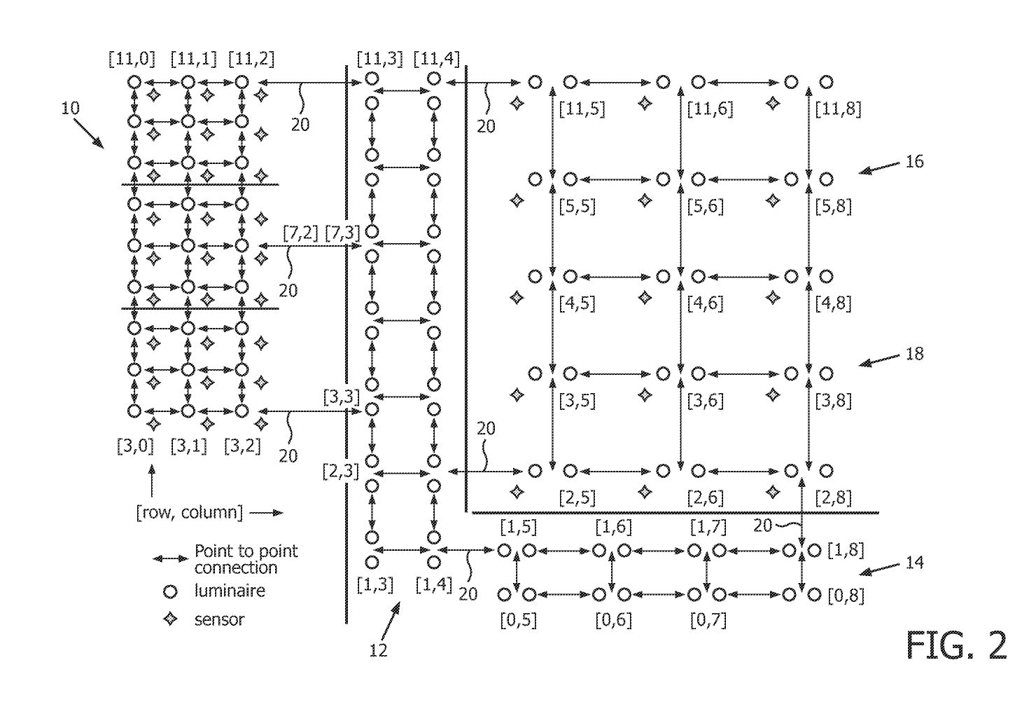

One single grid per floor is established by interconnecting nodes which lie opposite to each other, as shown in FIG. 2, which shows the same office floor with the same grids as in FIG. 1. Point-to-point links 20 have been laid between the grids. Using the numbering shown in FIG. 2, new link pairs are: ([11, 2], [11, 3]), ([[11, 4], [11, 5]), ([7, 2], [7, 3]), ([3, 2], [3, 3]), ([2, 4], [2, 5]), ([1, 4], [1, 5]), and ([2, 8], [1, 8]). In FIG. 2 the node addresses have changed with respect to those of FIG. 1, because configuration messages are exchanged over the point-to-point links 20, which initiate address changes of nodes in the grids 10, 12, 14 and 16. Because the density per column is much higher for the left part 10 of the grid than for the right part 16 of the grid, the numbering is discontinuous in the right part 16. For example node [5, 5] is the lower neighbor of node [11, 5]. Node [11, 5] acquires row number 11 from the left node [11, 2] via nodes [11, 3] and [11, 4]. Node [2, 8] acquires column number 8 from the lower node [1, 8]. FIG. 2 shows that each node has a unique address but it also shows that the numbering is less intuitive than for the individual building units, and depends on the implemented point-to-point links

In the second embodiment, interconnected grids are created:

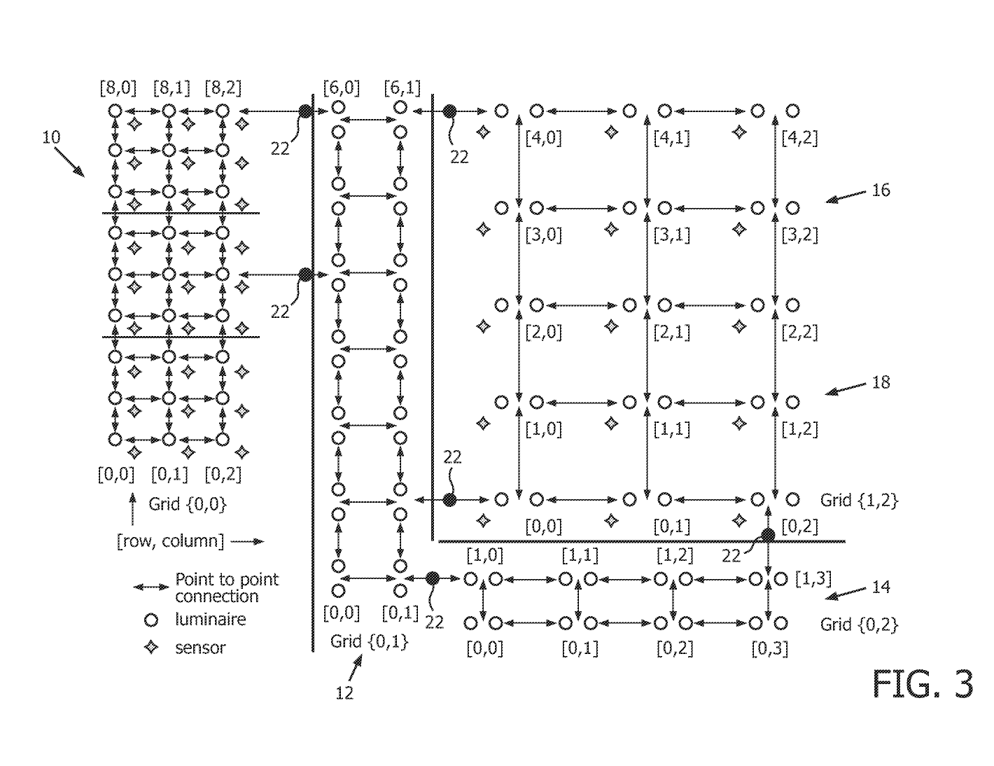

Instead of interconnecting the grids to one single grid, a grid of grids is created by interconnecting the grids with grid gateway nodes 22. At the same locations as the single point-to-point links 20 were inserted in FIG. 2, grid gateway nodes 22 have been added. FIG. 3 shows the grid nodes as black nodes connected to a point-to-point connection. A grid gateway node 22 connects grids in rows and columns. For every message which passes from left to right through a grid gateway node 22, the grid column number is increased by one. The same as the column number and row number of a single grid are determined, so that no address change of the nodes is required. In order to allow addressing nodes in the grid of grids, each grid 10, 12, 14, 16 has an assigned grid identifier {0, 0}, {0, 1}, {0, 2} and {1, 2} similar to the address with coordinates of the nodes. This second interconnection solution is a bit more expensive in nodes and installation since special grid gateway nodes are required but is also more flexible and intuitive.

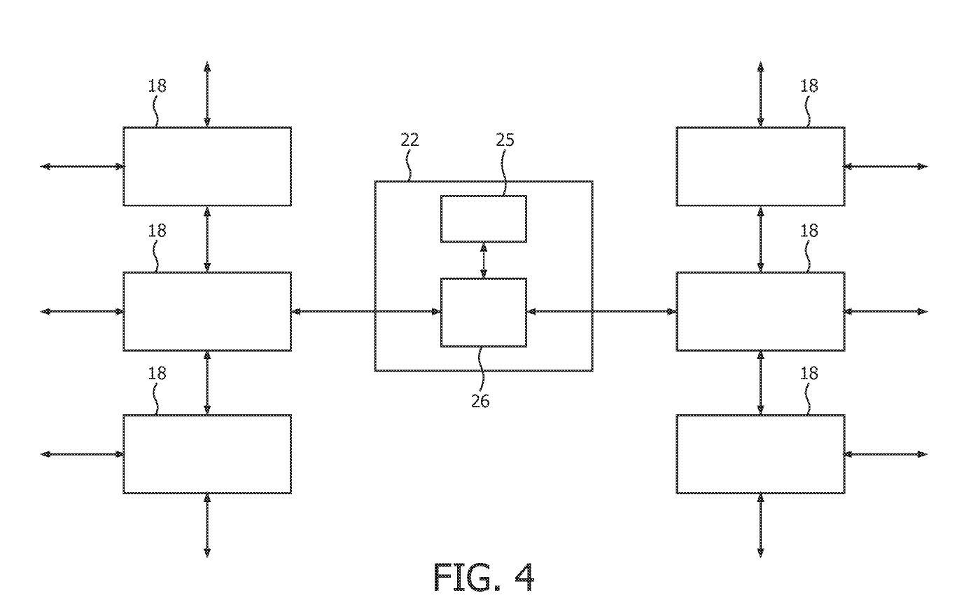

FIG. 4 shows a grid gateway node 22 in more detail. The node 22 comprises a transceiver 26 for receiving messages from and sending messages to other (standard) nodes 18. Furthermore, the grid gateway node 22 comprises routing means 25, which control routing over grids as described in the following.

Assuming that a lighting wired backbone network exists, it may make good sense to interconnect the grid nodes with the wired backbone. The grid gateway nodes may fulfill the gateway function foreseen for the lighting network between the backbone and the individual office unit networks. Standard routing techniques like AODV (Ad-hoc On-demand Distance Vector) can be used to find the path from the specified grid node to the destination grid node. This approach fits well with the running of the Internet Protocol (IP) over the backbone. In a grid gateway node, a lighting control software, for example executed by the routing means, unpacks a received message and sends it to the destination node in the grid. Within the grid, a suitable routing method may be used. The transformation of IP addresses used on the backbone to addresses used on the grid can be implemented with protocols proposed by the 6LoWPAN (acronym for “IPv6 over Low power Wireless Personal Area Networks”) working group of IETF.

An alternative method, decoupled from the Internet Protocol, is to provide a flat network wide routing over the grids. This implies that a network address is composed of the grid identifier and the grid address (location) within the selected grid. For routing purposes, every node may store the identifiers of all grids in each node. With each identifier, a node may also store the local grid address of the grid node through which a path to the given grid passes. Given the relatively low number of grids in a building and the hierarchical organization of the network, grid identifiers can be broadcast over the network. Without loss of generality, assume a node, k, in grid G with grid node g, and a grid H with grid node h exist. Grid node h broadcasts the grid identifier H and its own address h over the backbone. Grid node g will receive the message and stores the grid identifier H and the grid node address h in its memory. Grid node G broadcasts the grid identifier H with its own address g over grid G. Node k receives both H and g, and stores them in memory. When k sends a packet to a node m in H, it routes a packet to grid node g, g sends it on to h according to backbone routing rules, and h routes it to destination m in H.

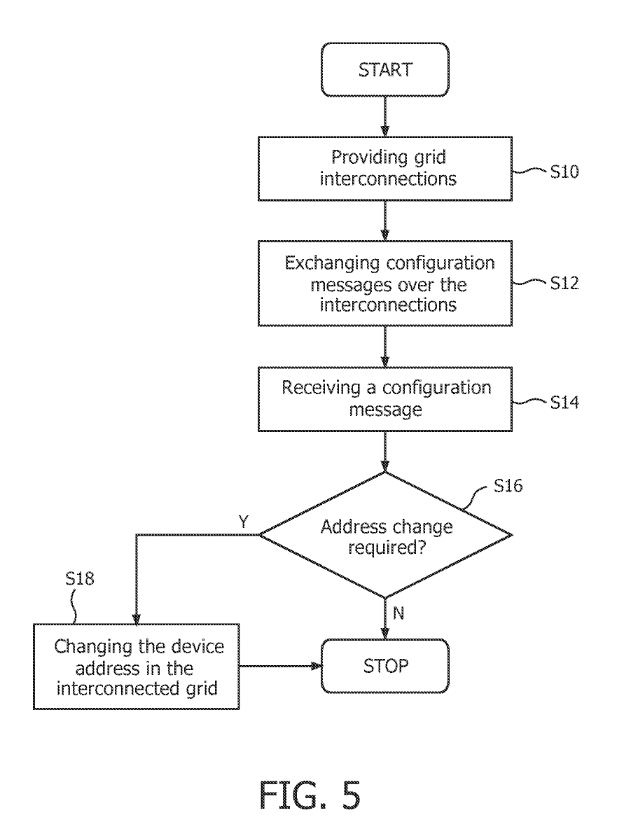

FIG. 5 shows a flowchart of an embodiment of a method for interconnecting grids according to the invention, wherein steps S10 and S12 are executed by the system, for example a central controller (not shown), and steps S14, S16, and S18 may be executed by a devices or nodes of grids, for example implemented as part of a firmware of a device or node. The method starts with step S10 providing interconnections between grids. For example, in step S10 a central controller may determine some devices or nodes of different grids, which are suitable for an interconnection and establishing a point-to-point link, refer to FIG. 3 and the node pairs ([11, 2], [11, 3]), ([[11, 4], [11, 5]), ([7, 2], [7, 3]), ([3, 2], [3, 3]), ([2, 4], [2, 5]), ([1, 4], [1, 5]), and ([2, 8], [1, 8]). Particularly, the determining of nodes or devices suitable for an interconnection may be selected depending on their position in the grids. In the next step S12, configuration messages for initiating changing addresses in the interconnected grids are exchanged between the interconnected grids. The configuration messages are sent out by the central controller. In principle, the configuration messages can be sent out also by the nodes or devices, for example by the nodes or device, which are part of an interconnection. The method continues with step S14, which is executed by devices of the interconnected grids. In step S14, a device receives a configuration message for initiating an address change. In the following step S16, the device checks whether an address change is required. The device can for example compare its own actual address in its original grid with an address space for the interconnected grid, which is contained in the configuration message. If the comparison results in that the actual address is not compatible with the address space, the device may continue with executing steps S18 for changing its address to a suitable address in the interconnected grid.

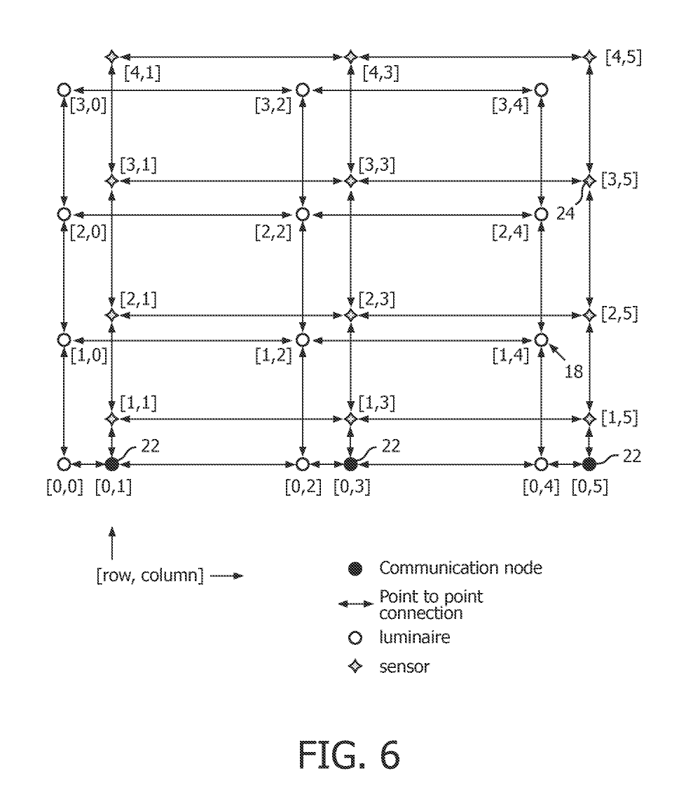

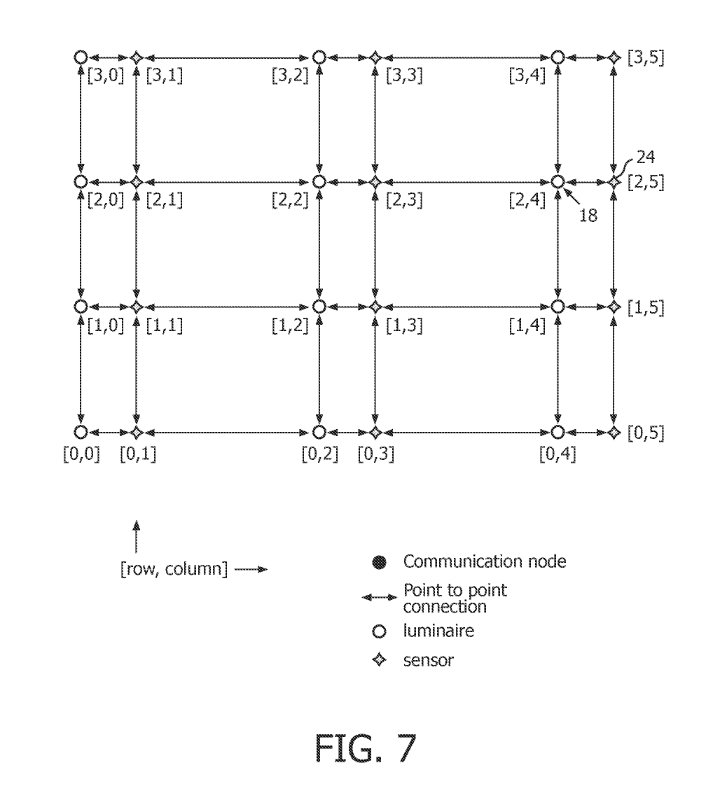

Next, embodiments of the integration of sensor and luminaire networks as shown in FIGS. 6 and 7 according to the invention are described. The integration of the sensor network and the luminaire network can be done in the same spirit as is done for integrating the luminaire grids of the building units on a floor. As shown in FIG. 6, one or more grid gateway nodes 22 can interconnect a grid of sensors (stars) 24 with a grid of luminaires (represented by the node 18) within the same building unit. In FIG. 6, two grids as shown in the left upper corner of FIG. 6 are interconnected with three grid gateway nodes 22 with the coordinates [0, 1], [0, 3] and [0.5]. FIG. 6 shows just one out of a set of possibilities. When the communication software in luminaire nodes, sensor nodes, and grid nodes is the same, the addresses shown in FIG. 6 will be allocated to the nodes. One integrated network per building unit is possible. These building units can be integrated as explained above. In the given example the sensor node row starts at [1, x] being connected to the grid node below. Adaptations to the grid node software make it perfectly possible that also the row numbers of the sensors start at 0.

Another solution calls for physically adapting the position of the sensors and luminaires to each other. This is shown in FIG. 7. The sensors have been moved next to the luminaires (in the example to the right but any of the other three directions is also possible). The final result is that one grid is used for the whole lighting infrastructure.

The network structures described above encourage a dynamic building up of a infrastructure usable by a central control program. After commissioning of devices of networked control systems of the building infrastructure, every node can communicate its position (address), device type and service type. This differs from the functionality provided by the UPnP (Universal Plug and Play) protocol or IETF SLP (Service Location Protocol) in some significant points:
1. The combined lighting sensor network is low speed and probably also low energy (no battery) and requires smaller packets than proposed for UPnP or SLP.
2. The grid location coupled with the building unit is an essential information.
3. The sensors and devices in a building network are different from Consumer Electronic Services in UPnP and need additional standardization

The invention can be applied in any networked control system such as a complex lighting system with a plurality of light sources, for example a lighting system installed in homes, shops and office applications. The invention is particularly applicable for large installations of networked control systems with interconnected devices, such as several networked lighting systems installed in a building.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1-15. (canceled)

16. A method to determine a relative position of a plurality of addressable devices on a network comprising a control unit in communication with the plurality of addressable devices, the method comprising the following steps:
selecting one of the plurality of devices, the other devices being remaining devices,
synchronizing the plurality of the devices,
providing a detection signal on the network, by means of the selected device, the detection signal being detectable by the remaining devices, wherein the detection signal has an amplitude that increases as a function of time,
determining a detection time for each remaining device, at which detection time said remaining device is able to detect the detection signal,
collecting the respective detection times of the remaining devices in the control unit, and
evaluating the detection times in order to determine the relative position of the plurality of devices.

17. The method of claim 16, wherein the detection time for a remaining device is determined as a time between synchronization and a first time that a signal above a predetermined level is determined by said device.

18. The method of claim 16, wherein the step of evaluating the detection times comprises ordering the detection times in an ascending order.

19. The method of claim 16, further including the step of providing to the control unit a wiring map of the network.

20. The method of claim 16, further comprising selecting one of the remaining devices, preferably with a highest detection time, and repeating the steps of synchronizing, providing a detection signal, determining and collecting the detection times, and re-evaluating the relative position of the plurality of devices.

21. The method of claim 16, wherein the network comprises a cable having substantially constant properties as to delay time and attenuation per unit length.

22. The method according to claim 16, wherein the detection signal comprises a signal having a frequency of between 10 kHz and 1 Mhz.

23. The method according to claim 22, wherein the detection signal comprises a signal having a frequency of between about 95 kHz and 148.5 kHz.

24. The method according to claim 16, wherein the amplitude of the detection signal is increased substantially linearly in time.

25. The method according to claim 16, wherein the amplitude of the detection signal is increased step-like with a time of constant amplitude of between about 1 millisecond and 5 second.

26. The method of claim 25, wherein the detection signal is increased in steps of between about 0.5 mV and 10 mV, preferably of between 1 mV and 5 mV.

27. The method of claim 26, wherein the detection signal is increased in steps of between about 1 mV and 5 mV.

28. A network of devices, comprising a cable, a plurality of addressable devices and a control unit connected thereto, the devices being provided with an internal clock which are synchronized to be able to measure time, and a selected device of the plurality of devices is able to provide a detection signal on the network, wherein the detection signal has an amplitude that increases as a function of time and each remaining device is able to determine a detection time, at which detection time said remaining device is able to detect the detection signal and the control unit is able to collect the respective detection times of the remaining devices, and to evaluate the detection times in order to determine the relative position of the devices.

29. The network of claim 28, wherein at least two devices are configured to supply and detect a detection signal and to determine an elapsed time.
